(19) United States
(12) Patent Application Publication
(10) Pub. No.: US 2011/0106294 A1
(43) Pub. Date: May 5, 2011

(54) Automatic battery exchange system for mobile vehicles

(75) Inventor: Charles P. Bebbington, Doylestown, PA (US)

(73) Assignee: John Bean Technologies Corporation, Chicago, IL (US)

(21) Appl. No.: 12/589,894

(22) Filed: Oct. 30, 2009

(51) Int. Cl. G06F 19/00; H02J 7/00; G05D 1/00; G06F 7/00; G06K 7/00

(52) U.S. Cl. 700/215; 320/109; 701/2; 700/213; 700/218; 235/375

(57) ABSTRACT

A battery exchange system for a battery-powered mobile vehicle comprises an exchanger automatic guided vehicle (“EAGV”) which is controlled by a central computer and which comprises a linking member that is temporarily connectable to the battery and a motive member that moves the battery at least horizontally relative to the mobile vehicle. During a battery exchange operation, the EAGV automatically engages the battery and removes the battery from the mobile vehicle. The EAGV may then automatically engage a charged battery and insert the charged battery into the mobile vehicle.

### BACKGROUND OF THE INVENTION

The present invention relates to a system for automatically replacing the batteries of battery-powered mobile vehicles. In particular, the invention is directed to a battery exchange system which includes an autonomous vehicle that is directed by a central computer to automatically replace the depleted batteries in the mobile vehicles with fully charged batteries.

Existing battery-powered mobile vehicles, such as automatic guided vehicles (AGV's), use one or more batteries which over time become depleted. Consequently, these batteries periodically need to be recharged on-board or replaced with fully charged batteries. If the batteries are charged onboard, then the mobile vehicle cannot perform its intended functions during the charging operation. It is therefore desirable to replace the depleted batteries with fully charged batteries in order to maximize the availability of the mobile vehicle to perform its intended functions.

Typical industrial traction batteries of the type commonly used in many mobile vehicles tend to be large and heavy. As a result, exchanging such batteries manually can be a strenuous and potentially dangerous task. On larger fleets of mobile vehicles, the task of exchanging batteries can became a continuous operation, thereby increasing the amount of manual labor required.

Various rail guided_battery exchange vehicles currently exist. While some of these vehicles are automated, most are believed to be manually operated. Even when automated, these vehicles are limited to traveling back and forth in straight lines along fixed rails mounted to the floor. Consequently, these vehicles do not have flexibility of use.

### SUMMARY OF THE INVENTION

In accordance with the present invention, these and other limitations in the prior art are addressed by providing a battery exchange system for a battery-powered mobile vehicle which includes at least one battery. The battery exchange system comprises an exchanger automatic guided vehicle (“EAGV”) which is controlled by a central computer and which comprises a linking member that is temporarily connectable to the battery and a motive member that moves the battery at least horizontally relative to the mobile vehicle. During a battery exchange operation, the EAGV automatically engages the battery and removes the battery from the mobile vehicle. The EAGV may then automatically engage a charged battery and insert the charged battery into the mobile vehicle.

In accordance with one embodiment of the present invention, the battery comprises at least one bracket and the linking member comprises a generally horizontal beam which engages the bracket. In this embodiment, the bracket may be connected to the top of the battery and the beam may be configured to be inserted through the bracket.

In accordance with another embodiment of the invention, the motive member comprises the EAGV, such that horizontal movement of the EAGV imparts horizontal movement to the battery. In addition, the motive member may comprise a lift device which is connected to the EAGV and which imparts vertical movement to the battery.

In accordance with yet another embodiment of the invention, the mobile vehicle comprises a first electrical coupler which engages a second electrical coupler on the battery to thereby electrically connect the mobile vehicle to the battery. In this embodiment, the first and second electrical couplers comprise automatic couplers. In addition, the mobile vehicle may comprise a battery guide member which is fixed in position relative to the first electrical coupler such that, upon insertion of the battery into the mobile vehicle, the second electrical coupler is aligned with the first electrical coupler.

In accordance with a further embodiment of the invention, the EAGV and the mobile vehicle are similar vehicles. In this embodiment, the EAGV is capable of functioning as the mobile vehicle and the mobile vehicle is capable of functioning as the EAGV.

In accordance with still another embodiment of the invention, the battery exchange system comprises a battery rack which includes a plurality of battery charger stations, each of which is adapted to support and charge a corresponding battery. In addition, each battery charger station may comprise a first electrical coupler which engages a second electrical coupler on the corresponding battery to thereby electrically connect the battery charger station to the battery. In this embodiment, the first and second electrical couplers may comprise automatic couplers. Furthermore, each battery charger station may comprise a battery guide member which is fixed in position relative to the first electrical coupler such that, upon insertion of the battery into the battery charger station, the second electrical coupler is aligned with the first electrical coupler.

In yet another embodiment of the invention, the battery exchange system comprises a dedicated battery exchange station in which the mobile vehicle and the EAGV are located during the battery exchange operation. In this embodiment, the dedicated battery exchange station comprises a supply of batteries from which the charged battery is obtained. In addition, the dedicated battery exchange station may comprise a temporary power supply for powering the mobile vehicle after the battery has been removed and before the charged battery has been installed.

In a further embodiment of the invention, the battery exchange system comprises a decentralized battery exchange station in which the mobile vehicle and the EAGV are located during the battery exchange operation. In this embodiment, the decentralized battery exchange station is located away from a supply of batteries from which the charged battery is obtained. In addition, the decentralized battery exchange station may comprise a temporary power supply for powering the mobile vehicle after the battery has been removed and before the charged battery has been installed.

In still a further embodiment of the invention, the battery is part of a set of batteries which each comprise a unique identification, and the central computer comprises information regarding the identification and location of each of the batteries in the set. In this embodiment, each of the batteries may include an identification tag comprising the unique identification of the battery, and the EAGV may comprise an identification tag reader. Also, the EAGV may comprise a communicator for communicating the unique identification of the battery to the central computer.

Thus, the present invention provides an automatic and flexible system for exchanging batteries in mobile vehicles. The EAGV comprises an automatically guided vehicle which is capable of autonomous movement without the use of fixed guide rails. In addition, the use of an EAGV eliminates the need for the mobile vehicle to travel to a central battery exchange/charge area to have its battery replaced, thereby minimizing the mobile vehicle's down time. Instead, the EAGV and the AGV may rendezvous at any convenient location for the battery exchange operation. Depending on the layout of the facility in which the mobile vehicles are used, this could reduce the number of mobile vehicles which are needed to carry out the required production tasks.

Also, depending on the utilization of the EAGV for carrying out the automatic battery exchange operations, the EAGV may also be used to perform production tasks, further enhancing the availability and productivity of the mobile vehicles. In this regard, the EAGV can be equipped with one or more load handling devices to transport production related loads.

Furthermore, in the case where more than one EAGV is provided in the system, they may be used to exchange each other's batteries.

In addition, the battery exchange system of the present invention does not require the use of a dedicated EAGV. Instead, the AGV's can be adapted to perform the battery exchange operation. Thus, the AGV's can perform the battery exchange operations on each other when required.

These and other objects and advantages of the present invention will be made apparent from the following detailed description, with reference to the accompanying drawings. In the drawings, the same reference numbers may be used to denote similar components in the various embodiments.

### BRIEF DESCRIPTION OF THE DRAWINGS

FIG. 1 is a top plan view of one embodiment of an exchanger AGV of the present invention shown being used to replace the battery of a conventional AGV;

FIG. 2 is a perspective view of the exchanger AGV of FIG. 1 shown being used to replace the battery of a conventional AGV, which for purposes of clarity is depicted mostly in phantom;

FIG. 3 is a top plan view of an exemplary production facility comprising a number of exchanger AGV's and conventional AGV's in operation; and

FIG. 4 is a perspective view of an embodiment of a battery storage and charging station forming a part of the present invention.

### DETAILED DESCRIPTION OF THE INVENTION

The present invention is directed to an automatic battery exchange system for battery-powered mobile vehicles. The invention provides an exchanger AGV (“EAGV”) which is programmed to automatically rendezvous with the vehicle, remove a depleted battery from the vehicle, reinstall a fresh battery in the vehicle and, preferably, place the spent battery in a battery charge location. The invention also provides a method for tracking the charge state of the vehicle's battery and directing the vehicle and the EAGV to rendezvous when the battery needs to be replaced. Although the invention may be used with any number and variety of battery-powered vehicles, including manually operated vehicles, it will be described herein in the context of a fleet of AGV's.

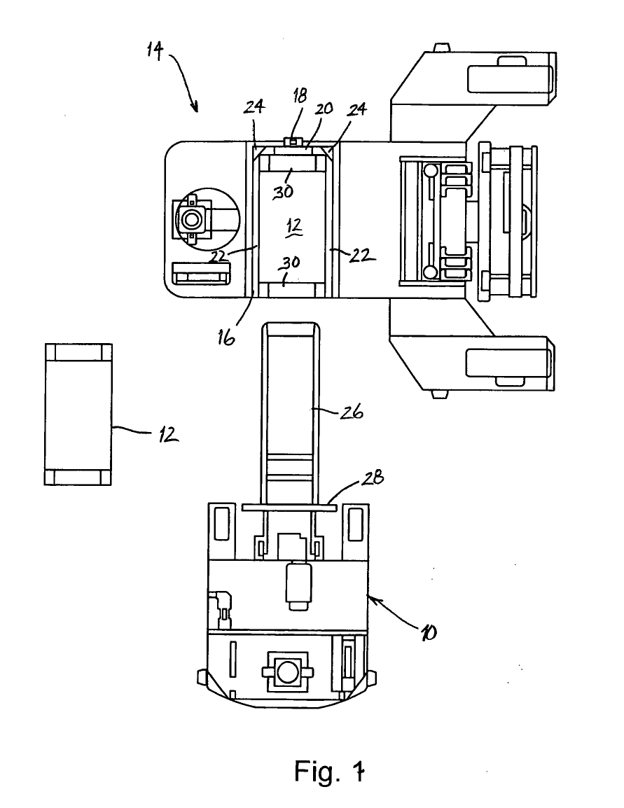

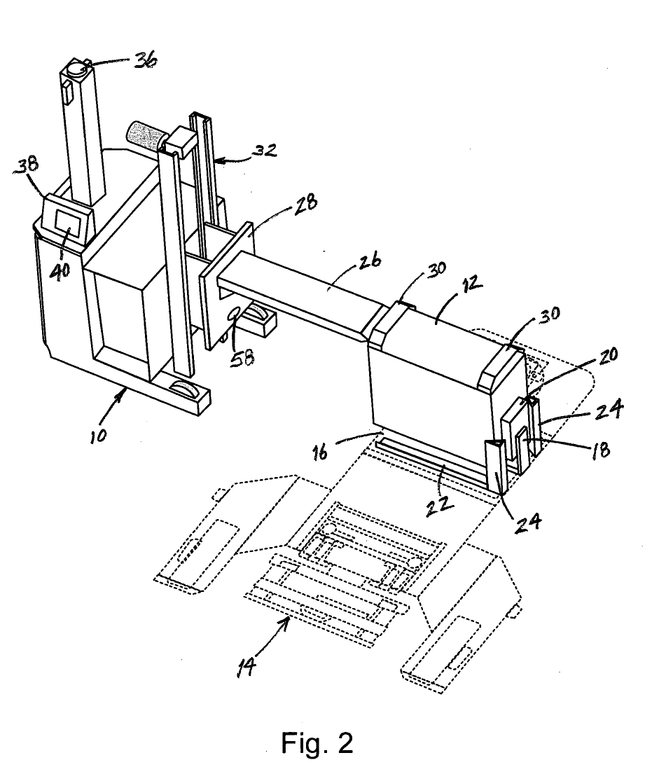

Referring to FIGS. 1 and 2, the battery exchange system of the present invention comprises an EAGV 10 which is shown being used to replace the battery 12 of a conventional AGV 14. The AGV 14 includes a battery compartment 16 in which the battery 12 is carried. The battery compartment 16 includes or is modified in a known manner to include means for removably connecting the battery 12 to the vehicle electronics (not shown) and means for guiding the battery into engagement with the removable connecting means. The removable connecting means may comprise, for example, an ordinary automatic coupler 18 which connects to a corresponding coupler 20 on the battery 12, preferably without the need for manual intervention. Thus, when the battery 12 is withdrawn from the battery compartment 16, the couplers 18, 20 will automatically disengage, and when a new battery 12 is inserted into the battery compartment, the couplers will automatically engage.

The guiding means may include, for example, a guide member which is fixed in position on the AGV 14 relative to the electrical coupler 18 so that, when the battery 12 is inserted into the battery compartment 16, the electrical couplers 18, 20 will align. In the embodiment of the invention shown in the drawings, the guide member includes a pair of guide rails 22 which are mounted on opposite sides of the battery compartment 16 and a pair of beveled posts 24 which are mounted at the rear of the compartment and which, when the battery 12 is inserted into the battery compartment, position the battery so that the coupler 18 engages the coupler 20 to thereby electrically connect the battery to the vehicle electronics.

The EAGV 10 comprises a conventional AGV which is provided with certain features to enable it to perform the automatic battery exchange function of the present invention. As with conventional AGV's, the EAGV 10 is capable of moving autonomously, preferably without the need for fixed guide rails. In addition, the EAGV 10 may be guided by any available guidance system, such as a laser, inductive wire, optic line/tape, or inertial/magnetic guidance system. This capability enables the EAGV 10 to maneuver independently of fixed rails and to roam the guidepath of the AGV 14.

As shown most clearly in FIG. 2, the EAGV 10 includes means for both engaging the battery and means for moving the battery into and out of the battery compartment 16. The battery engaging means comprise a linking member which is temporarily connectable to the battery 12 to enable the EAGV 10 to transfer a motive force to the battery during battery removal and insertion operations. In the illustrative embodiment of the invention shown in the drawings, the battery engaging means comprises a generally horizontal beam 26 which is mounted to the chassis of the EAGV 10 by a carriage 28. The beam 26 is configured to be inserted through a pair of spaced-apart brackets 30 which are connected to the top of the battery 12. In use, the beam 26 is maneuvered into the brackets 30 to bring the EAGV 10 into engagement with the battery 12.

Once the EAGV 10 has engaged the battery 12, the battery moving means moves the battery into and out of the battery compartment 16. The battery moving means may comprise any suitable motive member which is capable of imparting a horizontal force, and possibly also a vertical force, to the battery in order to move the battery into and out of the battery. Thus, the battery moving means functions to position the battery horizontally and, in a preferred embodiment of the invention, vertically as well. In the embodiment of the invention which is shown in the figures, the horizontal positioning function is provided by the EAGV 10 itself, which once aligned with the battery compartment 16 moves directly toward or away from the AGV 14 to insert the battery 12 into or remove the battery from the battery compartment, respectively. Alternatively, the horizontal positioning function may be provided by a conventional roller or conveyor device (not shown) which is connected to the beam 26 or the carriage 28. The vertical positioning function may be provided by a standard lift device 32 to which the carriage 28 is mounted.

During the battery removal procedure, the EAGV 10 is programmed to position itself opposite the battery 12 so that the beam 26 is aligned with the brackets 30. The EAGV 10 is then moved forward until the beam 26 is inserted through the brackets 30, the lift device 32 is activated to raise the battery 12 slightly off of the floor of the battery compartment 16, and the EAGV 10 is backed away from the AGV 14 to remove the battery from the battery compartment.

During the battery installation, procedure, the EAGV 10, with a battery 12 suspended from the beam 26, is programmed to position itself so that the battery is aligned with the battery compartment 16. The EAGV 10 is then moved forward an appropriate amount to insert the battery 12 into the battery compartment 16, the lift device 32 is activated to lower the battery 12 until it is fully supported by the floor of the battery compartment, and the EAGV is moved backward to withdraw the beam 26 from the brackets 30.

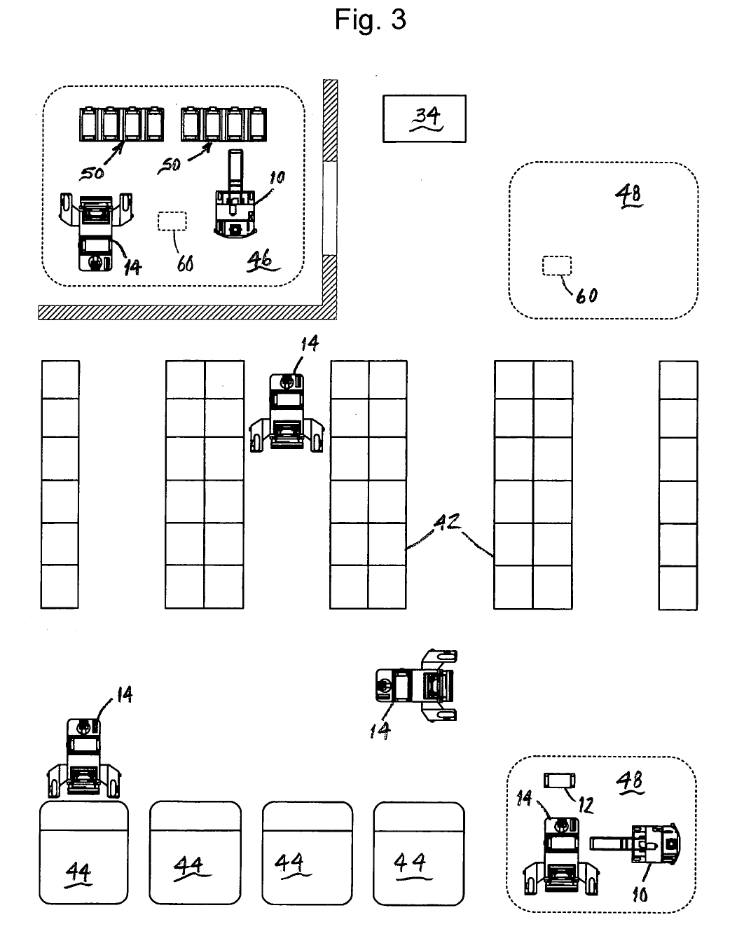

As with conventional AGV's, the EAGV 10 is ideally controlled by a central computer, which is indicated in FIG. 3 by reference number 34. If the EAGV 10 is used in conjunction with one or more AGV's 14, the EAGV may be controlled by the same central computer which is used to control the AGV's. The central computer 34 comprises, among other items, the control program for the EAGV 10 and means for interfacing this control program with the control program for the AGV's 14. The EAGV 10 includes an antenna 36 for communicating with the central computer 34 via, e.g., radio signals, and may also include an on-board computer 38 with a human interface such as a touch screen 40.

The battery exchange system of the present invention is particularly suitable for use in a production facility which employs a number of vehicles for performing various tasks. Referring to FIG. 3, for example, an exemplary production facility is shown in which five AGV's 14 are used to transport materials between a number of storage units 42 and one or more machines 44. In this embodiment of the invention, the battery exchange system includes two EAGV's 10 for servicing the AGV's 14, although one EAGV may be sufficient.

The battery exchange system ideally includes at least one dedicated battery exchange station 46 which is located, e.g., in a separate room of the production facility, and preferably also one or more decentralized battery exchange stations 48 which are located closer to the area of operation of the AGV's 14. In operation, an AGV 14 whose battery 12 needs to be replaced will rendezvous with an EAGV 10 at either the dedicated station 46 or one of the decentralized stations 48 so that the battery may be exchanged with a fresh battery.

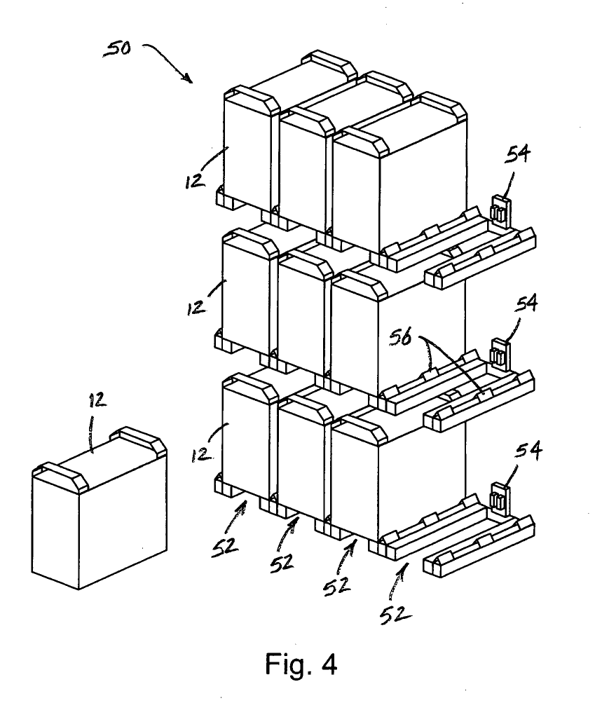

As shown in FIG. 4, the battery exchange system may also include at least one battery rack 50 for charging depleted batteries and storing fully charged batteries until they are needed. The battery rack 50 comprises a number of individual battery charger stations 52 which may be arranged horizontally and, if space is a premium, stacked vertically. Each battery charger station 52 includes an automatic coupler 54, similar to the coupler 18 on the AGV 14, for electrically connecting the battery 12 to a battery charging circuit (not shown), and preferably also a number of suitable guides 56 for positively locating the battery relative to the coupler as the battery is being inserted into the battery charger station.

An optional feature of the present invention is the ability of the central computer 34 to track the location and manage the charge of each battery 12 within the production facility. This may be accomplished by providing each battery 12, and preferably also each AGV 14 and each battery charger station 52, with a unique identifier, for example a distinct bar code or radio frequency identification (“RFID”) tag, and, as shown most clearly in FIG. 2, providing each EAGV 10 with a corresponding ID reader 58, for example on the carriage 28 below the beam 26. In this embodiment of the invention, the central computer 34 includes a database with information about the location and charge level of each battery 12. The location information may include, e.g., the particular AGV 14 or battery charger station 52 in which each battery 12 is located. During each battery exchange operation, the EAGV 10 communicates the identification of the battery 12 to the central computer 34. The central computer 34 then records the battery identification, the location of the battery and, if the location is a battery charger station 52, the time the charging operation begins and ends. In addition, the central computer 34 may be programmed to control the operation of each of the battery charger stations 52.

The battery exchange system of the present invention may include a means for powering certain components of the AGV 14, such as the on-board computer 38, during the battery exchange operation. Such means will allow the computer 38 to remain operational for communication purposes and avoid the need for rebooting after the battery has been replaced. The power retaining means may comprise a temporary on-board energy storage device, such as a small battery or capacitor, or an off-board power supply which is connected to the AGV 14 via an overhead rail, a floor plate, or an inductive coupler. In the embodiment of the invention shown in FIG. 3, for example, the power retaining means comprises a number of conventional floor plates 60, each of which is positioned at a designated battery exchange spot in one of the dedicated or decentralized battery exchange stations 46, 48.

In use, the EAGV's 10 are programmed to operate in a number of modes, two of which will now be described. The program which the central computer 34 employs to control the battery exchange system during each of these operating modes may be readily derived by the person of ordinary skill in the art from the following description of the major operating steps of each mode.

During both modes of operation, a standard battery sensor on the AGV 14 tracks the charge level of the battery 12 and, when the charge level drops below a predetermined minimum level, sends a “low battery” signal to the central computer 34. Alternatively, the AGV 14 may periodically read the battery sensor and send a signal indicative of the charge level to the central computer 34, which will track the charge level and determine if the charge level has dropped below the predetermined minimum level. In both cases, when the charge level has dropped below the predetermined minimum level, the central computer 34 will initiate a battery exchange operation.

In the first mode of operation, an AGV 14 whose battery is depleted travels under its own power to the dedicated battery exchange station 46. During this operation, the following steps may be executed:
Upon determining that the charge level of a particular battery 12 has dropped below the predetermined minimum level, the central computer 34 instructs the corresponding AGV 14 to travel to the dedicated battery exchange station 46.
The central computer 34 also instructs the EAGV 10 to travel to the battery exchange station 46 at this time.
Once both the EAGV 10 and the AGV 14 have arrived at the battery exchange station 46, the EAGV confirms with the central computer 34 that the AGV is parked in a designated exchange spot and is in “lockout” mode, i.e., is prevented from executing further instructions until the battery exchange operation has been completed.
The central computer 34 then interrogates its database to determine which battery charger stations 52 are unoccupied and instructs the EAGV 10 to remove the depleted battery 12 from the AGV 14 and place it in an unoccupied battery charger station.
The central computer 34 then determines which of the batteries currently in the battery rack 50 are fully charged and communicates the location of one of these batteries to the EAGV 10.
The EAGV 10 then retrieves the fully charged battery 12 from its corresponding battery charger station 52 and installs it in the AGV 14.
Once the transfer is complete, the central computer 34 releases the AGV 14 from lockout mode and the AGV is ready to carry on with its normal tasks.

In the second mode of operation, an AGV 14 whose battery is depleted travels under its own power to one of the decentralized battery exchange stations 46 and the EAGV 10 performs the battery exchange operation at this location. During this operation, the following steps may be executed:
Upon determining that the charge level of a particular battery 12 has dropped below the predetermined minimum level, the central computer 34 instructs the corresponding AGV 14 to travel to the decentralized battery exchange station 48.
The central computer 34 also instruct the EAGV 10 to travel to the battery rack 50 and collect a fully charged battery 12.
The EAGV 10 then transports the fully charged battery 12 to the decentralized battery exchange station 48.
Upon arrival at the decentralized battery exchange station 48, the EAGV 10 sets the fully charged battery 12 off to the side, either on the floor or a prepositioned battery stand (not shown).
After confirming with the central computer 34 that the AGV 14 is parked in a designated exchange spot and is in “lockout” mode, the EAGV 10 removes the depleted battery 12 from the AGV and sets it off to the side, either on the floor or a prepositioned battery stand.
The EAGV 10 then picks up the fully charged battery 12 and installs it in the AGV 14.
Once the transfer is complete, the central computer 34 releases the AGV 14 from lockout mode and the AGV is ready to carry on with its normal tasks.
The EAGV 10 then picks up the discharged battery 12 and transports it to the battery rack 50.
The central computer 34 then interrogates its database to determine which battery charger stations 52 are unoccupied and instructs the EAGV 10 to place the depleted battery 12 in an unoccupied battery charger station.

Many variations of the present invention may be derived from the teachings set forth above. For example, the battery exchange system need not comprise a dedicated EAGV. Instead, some or all of the AGV's in a production facility could be adapted to perform the battery exchange operations, in which event the AGV's would be used not only to perform their normal tasks, but also to exchange each other's batteries when necessary. Also, the same EAGV need not be used to both remove the depleted battery from the AGV and reinstall a charged battery into the AGV. Instead, one EAGV could be used to remove the depleted battery while another EAGV retrieves a charged battery and then installs it in the AGV. Also, the EAGV could be used to replace the batteries of a variety of mobile vehicles, including battery-powered automobiles and lift trucks.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. A battery exchange system for a battery-powered mobile vehicle which includes at least one battery, the battery exchange system comprising:
an exchanger automatic guided vehicle (“EAGV”) which is controlled by a central computer and which comprises a linking member that is temporarily connectable to the battery and a motive member that moves the battery at least horizontally relative to the mobile vehicle;
wherein during a battery exchange operation, the EAGV automatically engages the battery and removes the battery from the mobile vehicle.

2. The battery exchange system of claim 1, wherein during the battery exchange operation the EAGV automatically engages a charged battery and inserts the charged battery into the mobile vehicle.

3. The battery exchange system of claim 1, wherein the battery comprises at least one bracket and the linking member comprises a generally horizontal beam which engages the bracket.

4. The battery exchange system of claim 3, wherein the bracket is connected to the top of the battery and the beam is configured to be inserted through the bracket.

5. The battery exchange system of claim 1, wherein the motive member comprises the EAGV, such that horizontal movement of the EAGV imparts horizontal movement to the battery.

6. The battery exchange system of claim 5, wherein the motive member further comprises a lift device which is connected to the EAGV and which imparts vertical movement to the battery.

7. The battery exchange system of claim 1, wherein the mobile vehicle comprises a first electrical coupler which engages a second electrical coupler on the battery to thereby electrically connect the mobile vehicle to the battery.

8. The battery exchange system of claim 7, wherein the first and second electrical couplers comprise automatic couplers.

9. The battery exchange system of claim 7, wherein the mobile vehicle comprises a battery guide member which is fixed in position relative to the first electrical coupler such that, upon insertion of the battery into the mobile vehicle, the second electrical coupler is aligned with the first electrical coupler.

10. The battery exchange system of claim 1, wherein the EAGV and the mobile vehicle are similar vehicles, such that the EAGV is capable of functioning as the mobile vehicle and the mobile vehicle is capable of functioning as the EAGV.

11. The battery exchange system of claim 1, further comprising a battery rack which includes a plurality of battery charger stations, each of which is adapted to support and charge a corresponding battery.

12. The battery exchange system of claim 11, wherein each battery charger station comprises a first electrical coupler which engages a second electrical coupler on the corresponding battery to thereby electrically connect the battery charger station to the battery.

13. The battery exchange system of claim 12, wherein the first and second electrical couplers comprise automatic couplers.

14. The battery exchange system of claim 12, wherein each battery charger station comprises a battery guide member which is fixed in position relative to the first electrical coupler such that, upon insertion of the battery into the battery charger station, the second electrical coupler is aligned with the first electrical coupler.

15. The battery exchange system of claim 1, further comprising a dedicated battery exchange station in which the mobile vehicle and the EAGV are located during the battery exchange operation, the dedicated battery exchange station comprising a supply of batteries from which the charged battery is obtained.

16. The battery exchange system of claim 15, wherein the dedicated battery exchange station comprises a temporary power supply for powering the mobile vehicle after the battery has been removed and before the charged battery has been installed.

17. The battery exchange system of claim 1, further comprising a decentralized battery exchange station in which the mobile vehicle and the EAGV are located during the battery exchange operation, the decentralized battery exchange station being located away from a supply of batteries from which the charged battery is obtained.

18. The battery exchange system of claim 17, wherein the decentralized battery exchange station comprises a temporary power supply for powering the mobile vehicle after the battery has been removed and before the charged battery has been installed.

19. The battery exchange system of claim 1, wherein the battery is part of a set of batteries which each comprise a unique identification, and wherein the central computer comprises information regarding the identification and location of each of the batteries in the set.

20. The battery exchange system of claim 19, wherein each of the batteries includes an identification tag comprising the unique identification of the battery, and wherein the EAGV comprises an identification tag reader.

21. The battery exchange system of claim 20, wherein the EAGV comprises means for communicating the unique identification of the battery to the central computer.
